(19) United States
(12) Patent Application Publication
(10) Pub. No.: US 2017/0036101 A1
(43) Pub. Date: Feb. 9, 2017

(54) Apparatus for Determining a Straight Line Segment Between the Center of Multiple Two Dimensional Objects or Areas.

(71) Applicant: Kenneth Ray Duckworth, Jr., Sunnyvale, CA (US)

(72) Inventor: Kenneth Ray Duckworth, Jr., Sunnyvale, CA (US)

(21) Appl. No.: 14/817,111

(22) Filed: Aug. 3, 2015

(51) Int. Cl. A63F 3/00; G01B 5/14

(52) U.S. Cl. CPC A63F 3/00895; G01B 5/14; A63F 3/00075

(57) ABSTRACT

One embodiment is made up of an outer casing with internal mechanisms that allow for a cable to be housed inside of it and pulled out upon operation. The retractable element of this embodiment keeps tension on the cable. This cable is pulled through the center of two separate three dimensional objects and is tethered to the side farthest from which the above embodiment rests. There are vertical penetrating holes in the center of each three dimensional object that allow the cable to pass through freely. The holes are strategically placed in the center of each three dimensional object.

### CROSS-REFERENCE TO RELATED APPLICATIONS

None.

### FEDERALLY SPONSORED RESEARCH

None

### SEQUENCE LISTING

None.

### BACKGROUND

There is a worldwide table top game called Heroclix that has a long list of rules. Heroclix consist of miniature characters from different fictional universes such as Marvel, DC, Pacific Rim, Yu-Gi-Oh, Assassins Creed, and Star Trek for example. These characters are placed on a map made of a thick paper with detailed drawings to resemble different environments. Some examples of these maps are Atlantis, Surface of the Moon, and Killian's Mansion. The point of this game is to defeat your opponent's characters by attacking them and dealing damage until they are KO'd. There are movement actions which allow you to get adjacent, meaning very close to the enemy in which usually a close combat attack is made. There are also actions that allow you to make ranged combat attacks and actions. For this ranged attack you must target your opponent. This is also a necessity for some other game elements such as outwit which allows you to counter a power that your opponent has, or perplex which allows you to increase or decrease combat values associated with a character.

This is where the issue of drawing a line of fire comes in. There are some objects and game elements that the rules do not allow you to attack through. In these cases you have to determine line of fire, meaning, can the attacking character draw a straight line from the middle of the square they occupy to the middle of the square the opponent occupies without such an object or game element being in the way of that line. If that line passes through any part of any square on the map that would block that line, then it is blocked or a game effect would be applied to the attack.

Previously any item that would create a straight line has been used like a piece of paper, a ruler, or a piece of string. The issue with this is the low accuracy of these tools, because there is no way to guarantee that the line is being drawn from and to the center of each square. The inaccuracy of a single millimeter when drawing this line can be the difference in winning and losing the whole match.

In conclusion, to my knowledge there is no tool that provides a way to draw this line to the center of each square in this way.

### SUMMARY

This improved tool has two independent objects stacked on top of one another. One embodiment is attached to the top element. The cable from this embodiment is pulled through a vertical hole in the center of each object starting with the top object and ending with the bottom object. A knot is made at the end of the cable after it has been pulled through both objects.

The advantages to these items working together are having an accurate center of each object. The advantages are the accuracy of determining the center of the two objects along with determining the straight line segment that passes through the center of both objects.

The embodiment is made up of a front and back reel housing with a coiled spring and inner reel that work together in order to create the retractable nature of the cable that comes out.

### DRAWINGS

FIG. 1 is a three dimensional perspective view of the fully constructed apparatus.

FIG. 2 is a three dimensional perspective view of the top element.

FIG. 3 is a three dimensional perspective view of one embodiment.

FIG. 4 is a perspective view of the bottom element.

### DETAILED DESCRIPTION

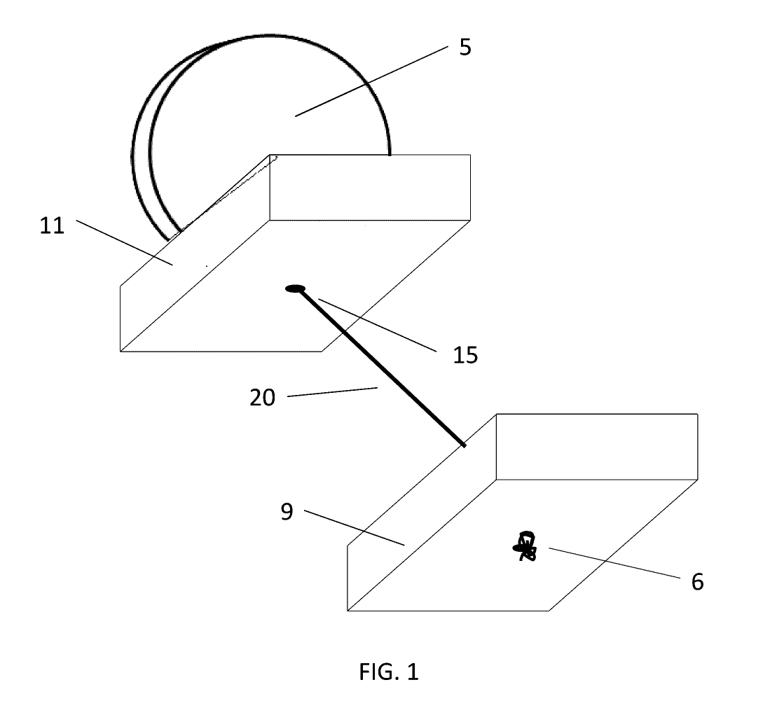

FIG. 1 schematically illustrates the constructed apparatus with the retractable reel housing (5) secured to the top element (11). The cable (20) passes through the top element (11) via the top element centered hole (15) first, then passes through the bottom element (9) via the bottom element centered hole (17). A cable knot (6) is made after the cable (20) passes through the bottom element (9) via the bottom element centered hole.

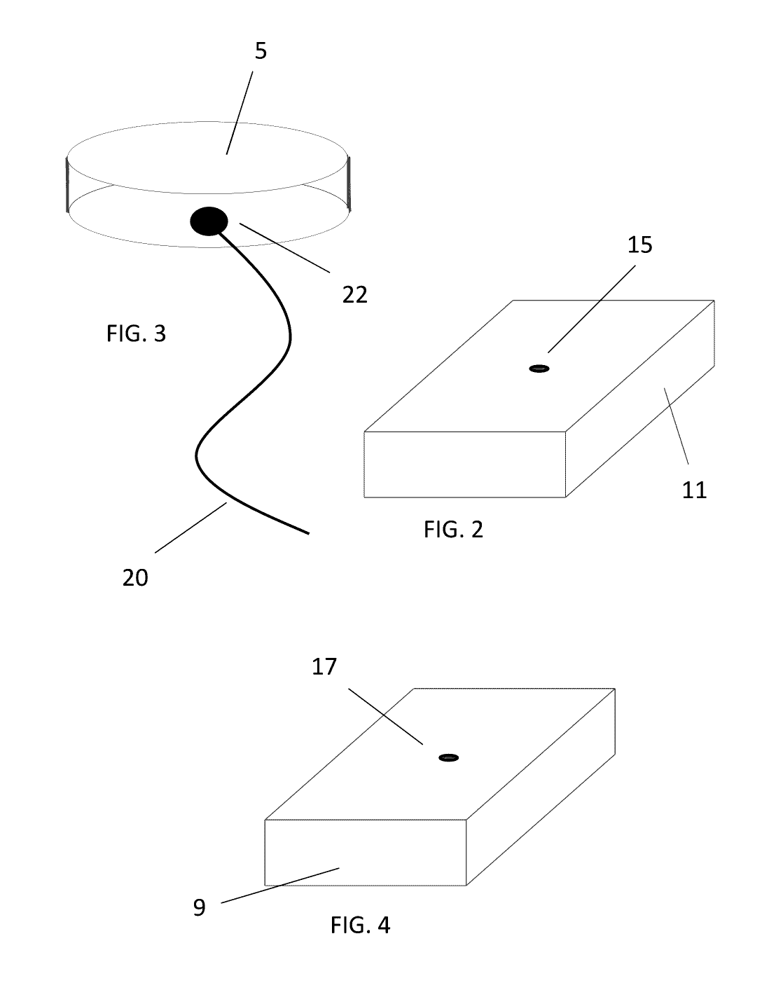

FIG. 2 schematically illustrates the top element (11) with the top element centered hole (15) that penetrates completely through top element (11).

FIG. 3 schematically illustrates the retractable reel housing (5) with the cable (20) protruding from the retractable reel cable feed (22).

FIG. 4 schematically illustrates the bottom element (9) with the bottom element centered hole (17) that penetrates completely through the bottom element (9)

### REFERENCE NUMERALS

5-Retractable reel housing
6-Cable knot
9-Bottom element
11-Top element
15-Top element centered hole
17-Bottom element centered hole
20-Cable
22-Retractable reel cable feed

### OPERATION

In operation the user holds the top element (11) in one hand and the bottom element (9) in the other hand. The user places the top element (11) on the first two dimensional object then places the bottom element (9) upside down on the second two dimensional object. As the user pulls the bottom element (9) away from the top element (11), the cable (20) will be pulled out of the retractable reel housing (5) and retractable reel cable feed (22). The retractable reel cable will keep tension during this process to maintain a straight line segment and shortest distance between the top element centered hole (15) and the bottom element centered hole (17). After use, the retractable reel housing (5) will pull the cable (20) back into the retractable reel housing (5) and because of the cable knot (6), the bottom element (9) will also be pulled back to the top element (11) until the bottom of the top element (11) sits flush with the top of the bottom element (9). When the apparatus operates in this manner some advantages that occur are:

A-The construction of the top element (11) having the top element centered hole (15) and bottom element (9) having the bottom element centered hole (17) allow the user to determine the center of each two dimensional object with little effort.

B-Placing the bottom element (9) upside down allows the cable (20) to lie flush with a two dimensional surface increasing accuracy of determining the straight line segment between the top element centered hole (15) and the bottom element centered hole (17).

C-Both the top element (11) and the bottom element (9) return to the resting position after use.

### CONCLUSIONS, RAMIFICATIONS, AND SCOPE

By the above specifications the reader of this document will acknowledge the accuracy in determining the center of multiple two dimensional objects or areas while also determining the line segment and the path of this line segment between these centered points. Other variations are possible outside of the illustrations provided as there are many options for shapes that the top element (11) and bottom element (9) can be. The maximum length of the cable (20) is variable, and may be made of different materials or have different colors.

The retractable reel housing (5) can be made of different colors, materials, or a different size. The retractable reel housing (5) can be eliminated in the event that the internal mechanisms are incorporated directly into the top element (11) or bottom element (9). Both the top element (11) and bottom element (9) can be made of different materials, come in different colors or have different shapes.

The cable knot could be eliminated and incorporated into the bottom element (9) or by having the cable (20) attached to the bottom element (9) in another way. The internal mechanisms of the retractable reel housing (5) can be made up of variable components.

1. an embodiment that determines the center point of two objects and the line segment between those two points

2. the embodiment in claim 1 comprised of a bottom element sitting under a top element both with vertical holes in their center

3. the top element of claim 2 having a retractable reel housing attached

4. the retractable reel housing of claim 3 having a cable within, that can be drawn out by pulling

5. the cable of claim 4 is pulled simultaneously through the top element, then through the bottom element

6. wherein the cable is secured to the bottom side of the bottom element of claim 2,

7. wherein the retractable reel housing applies retracting tension to the cable in claim 4

8. allowing the top element of claim 2 to be placed on a surface with the same area as the bottom side of the top element, and

9. allowing the bottom element of claim 2 to be placed on a surface with the same area as the top side of the bottom element

10. requiring the bottom element be placed top side down on said surface and the top element being placed bottom side down on said surface

11. the placement of the elements of claim 10, determining the centers of the areas on said surfaces under the top element and bottom element, also

12. the placement of the elements of claim 10, determining the line segment between the center of the chosen areas, and

13. when finished with use the retractable reel housing returns the bottom element and top element to one another.
